(19) United States
(12) Patent Application Publication
(10) Pub. No.: US 2012/0226901 A1
(43) Pub. Date: Sep. 6, 2012

(54) System, Method and Apparatus For Secure Telecommunications In A Home Area Network

(75) Inventors: Pramod Pandey, Unterhaching (DE); Joshua Grossman, Gardner, MA (US); Daniel Scharfen, Hebertshausen (DE)

(73) Assignee: LANTIQ DEUTSCHLAND GMBH, Neubiberg (DE)

(21) Appl. No.: 13/224,386

(22) Filed: Sep. 2, 2011

Related U.S. Application Data
(60) Provisional application No. 61/379,707, filed on Sep. 2, 2010.

(51) Int. Cl. H04L 9/00

(52) U.S. Cl. 713/150

(57) ABSTRACT

Secure message transfer is provided in a network including at least a Home Area Network (HAN) having network devices A, B and C. The Home Area Network is capable to connect domains having different transmission formats and includes a secure communication protocol. Device A is capable to communicate at least one message to the device C according to the secure communication protocol, and device B is capable to receive at least one message from device A sent for reception and decryption by device C. A device D controls the secure message transfer and selectively disables device B from decrypting the message received by device B that is sent from device A to device C for decryption.

### RELATED APPLICATION

The instant application claims priority from U.S. Provisional entitled “Method and Apparatus to Utilize a Single Security Controller For Transporting Encrypted HAN”, U.S. Ser. No. 61/379,707, filed on Sep. 2, 2010.

### FIELD OF THE INVENTION

The present invention relates to a Home Network and a method for providing Home Networking and, more particularly, for securing data transmitted over a Home Network and between different networks.

### BACKGROUND

A Home Network or Home Area Network (HAN) is known by the skilled artisan as a residential local area network (LAN or RAN) that is used for communication between digital devices within a home or residence. The HAN typically connects devices that communicate in different formats called domains, including broadband and non-broadband signaling domains.

A RAN usually includes one or more personal computers, accessories, such as printers and mobile computing devices. It is anticipated that household connection through home networks will soon be widespread in the United States. Thus, it is expected that the HAN will integrate all electronic devices in the household including televisions, VCRs or Video Recorders, Video Playback machines, telephones or IP phones, faxes, and game consoles, for example.

For that matter, any household appliance, such as air conditioning, heating units, hot water boilers, solar and thermal energy devices, battery cells and even home security systems will soon be connected to the Home Area Network. These electronic devices are further expected to have smart parts, i.e., microprocessors and supporting logic and memory, that will enable them to send and receive data via the Home Network thereby providing a truly integrated home.

The skilled artisan is aware of and understands the design of a Home Area Network and its components. As a concrete example, various standards that have recently been adopted subsequent to this application set forth the well-accepted design of a Home Area Network. For example, FIG. 1 illustrates one such design for a Home Area Network 100 set forth in the ITU G.9660 (G.hn), which shall now be explained in more detail. However, other corollary standards are known to the skilled person in the art including G.9661, G.hnem, HomePlug, Home PNA, and IEEE 1901. It shall be understood that these standards continually evolve and that future evolutions of these standards and their corollaries are relevant to the current discussion.

FIG. 1 shows a Home Area Network 100 having a number of domains 102a, b . . . s (Domain 1, Domain 2 to Domain S). A domain is known, and defined in ITU-T G.9960, to comprise the domain master and one or more nodes that are registered with the same domain master. Thus, in the example of FIG. 1, Domain 1 102a includes domain master 104a and one or more nodes 106a. The other domains, Domain 102b . . . 102s, may have similar or different components but are shown here to include also a domain master 104b or 104s. The domain master assigns and coordinates resources, such as bandwidth and priorities of the nodes in its domain.

One of the domains 104a, b . . . s assumes the role of global master (GM) that provides coordination between different domains. This coordination (generally indicated by reference numeral 108) includes allocating communication resources, priority setting, announcing policies of domain masters, and mitigating crosstalk. A global master may also convey management functions initiated by the remote management system (e.g., the Broadband Forum, CPE, WAN management protocol) to support broadband access.

An inter-domain bridge (generally denoted by reference numeral 110) bridges the various domains 104a, b . . . s. The inter-domain bridge may exist, for example, above the physical layer to interconnect nodes of two different domains. An alien domain 112a and/or 112b, that is a group of non-Home Network nodes connected to the same medium or operating in close proximity, may also connect and become a part of the Home Area Network. The bridging function to an alien domain, as well as coordination with an alien domain, is well known in the art.

According to the ITU standards, a domain 102a, b . . . s can operate in at least three modes: peer-to-peer mode (PM), centralized mode (CM), or unified mode (UM). In fact, different domains within the home network can use different modes of operation, i.e., PM, CM, or UM. Broadcast and multicast is supported in any domain, independent of its operational mode (PM, CM or UM). In PM, only P2P is used in the domain. Thus, direct signal traffic is established between two communicating nodes. In CM, only relayed communication (REL) is used by way of a domain access point (DAP), the unique node in centralized mode (CM) that supports relay functionality through which all nodes communicate. Thus, any node of the domain in CM mode can communicate with another node only through the DAP. In UM, a hidden node in a domain can communicate with another node through a relay node.

The HAN 100 shown in FIG. 1 may be thought to include Infrastructure Devices and Client Devices. The infrastructure devices provide the underpinnings of the Home Area Network and, therefore, are likely to be the domain masters 104a, b . . . s. However the infrastructure devices may also be nodes 106a, b . . . s themselves. As a corollary, the client devices are typically the devices that send the communications within the network and, therefore, are usually the nodes 106a, b . . . s. As with the infrastructure devices, the nodes themselves may take on coordination and also perform the role of domain master. It is also pointed out that the role of domain master can change over time, such that the role of domain master can change from instant to instant.

Infrastructure Devices include broadband modems for connection to the internet, which is for example a DSL modem using the phone line, a wireless lan (WLAN) modem, or a cable modem using a cable Internet connection. Another infrastructure device is a residential gateway (known in the art as a router) connected between the broadband modem and the rest of the network, and may be embodied as a wireless access point. The gateway's function is to enable multiple devices to connect to the Internet simultaneously. Gateways, or so-called residential gateways, that is hubs/switches, DSL modems, and wireless access points are sometimes combined into a single unit. The wireless access point is usually implemented as a feature rather than a separate box for connecting wireless devices. As mentioned above, the modems or gateways typically take on the role of domain master, but may also take direction from another domain master and, therefore, function as nodes.

Client Devices may include a PC, or multiple PCs including laptops, Net books and Tablet PC's. These may also include entertainment peripherals, including DVRs like TiVo, digital audio players, game machines, stereo systems, and IP set-top boxes as well as TVs themselves. Further Client Devices that are finding their way more often into the home include Internet Phones (VoIP) and Smart Phones connected via Wi-Fi, for example. While client devices are typically the “users” of the Home Area Network, it is reiterated that the nodes may also take on a coordinating function and, therefore, act as the domain master in FIG. 1.

Bridges 110a or b, which connect two networks together, may be provided by a number of devices to connect different domains. These may bridge devices that are a part of the HAN, namely inter-domain bridges 110a, or may bridge devices of internal and alien domains 110b. For example, a wired device may be bridged to a wireless domain using any device that has both wired and wireless access, such as an Xbox game console. Other bridges may be formed to connect other types of devices as well. A network hub/switch may be used as a central networking hub containing a number of Ethernet ports for bridging multiple networked devices. A network attached storage (NAS) device can be used for bridging various storage devices on the network. A print server can act as a print bridge used to share printers among computers on the network.

It should be apparent by this time that the HAN is an open-ended network that connects to a variety of domains and telecommunication formats. In such a network, security is difficult to provide and is a key concern by HAN designers and providers, as well as device manufacturers. For one thing, any number of devices may connect into the HAN, any of which may be of dubious integrity. For another, the domains can connect externally to alien domains, which may be host to any number of untrusted entities. More insidious, however, is the nature of the HAN itself which allows any of the devices to actively become the domain master, or worse the global master. Consider that any entity can assume the role of domain or global master and it is at once understood how difficult and vexing security in such a network can be.

Further, and as mentioned above, a HAN can communicate in a number of different modes. Peer-to-peer mode (PM), centralized mode (CM), or unified mode (UM) are all provided for in a HAN network. This compounds the network security problem by forcing the designer of the network to consider various modes of communication that need to be secured.

This is to be contrasted with end-to-end security that is much simpler to maintain than the open ended case. In an end-to-end communication, security is usually provisioned in Software (S/W) via a shared or a distributed key/password. Take, for example, the case of blue tooth devices that form private networks called Piconets. In that case, only trusted devices are allowed to enter only if strict handshaking and encryption key conditions (called authentication) are met. However, such key and password systems work in an end-to-end security network only because the key is given to a closed number of devices. The same is not true for open-ended systems, particularly powerline (which communicates through the power lines within a residence), cable, or any medium that connects to remote or unknown locations in the residence.

In contradistinction to the end-to-end system, the open environment of the Home Network allows almost any device to receive and route messages that include the security keys. In particular, such an open-ended HAN network necessarily passes the encryption keys to a number of devices along the way to the end device designated to receive encrypted communications. Moreover, it is part of the current methodology to decrypt the key when received by an intermediary device and to re-encrypt and forward the key to the next device in the link. In other words, any device of the HAN has access to the unencrypted key. This reveals a weakness that allows virtually any device in the Home Area Network to have access to the key or password, thereby compromising the complete security infrastructure at home.

In addition, the Software stack itself is vulnerable to be hacked since the keys and encryption algorithm are Software provided. For example, the infrastructure could be replaced by spyware, which would have access to data even before security algorithms are applied. As mentioned above, this vulnerability is compounded by the fact that the security key is routed through or provided in various devices of the Home Network. In the case where the device itself is the domain master that is hacking the network, the keys themselves are subject to subversion and the hacking device can take over the entire HAN.

To combat the security weakness of the HAN described above, a hardware solution is theoretically imaginable. Such a hardware system would have a hardwired key at either end of the communication. In that way, no intervening device would have the capaility to decrypt the secured key. However, such a solution would require a custom hardware to be integrated at both ends of each communication, i.e., sender and recipient ends. First, this would make mass deployment of secured communication channels to home devices prohibitively expensive, as every device in the HAN would need a special chip. Next, each device would have to be given its own unique key. In a network of potentially unlimited devices, such a chip key solution is nearly impossible. More likely, in practice only a few devices would be equipped with such a hardware chip solution and the vast number of devices connected to the HAN would neither have such protection nor be able to communicate securely with secured devices. Providing custom hardware as noted is expensive and unsuitable for mass deployments in a consumer home environment.

Software solutions have been proposed to solve the problem of the security issues of the HAN. However, any software solution must be constantly updated with newer versions of software. In the same sense as a hardware solution, much time and money must be spent on providing these updates. Moreover, the software solution must constantly be engineered to take into account updates of the HAN system or its devices. Until now, no solution exists to solve the problem of the insecure nature of a Home Area Network.

### BRIEF DESCRIPTION OF THE DRAWINGS

FIG. 1 illustrates a Home Area Network (HAN) to which the instant application relates;

FIG. 2a illustrates an encryption procedure of an LLC frame to which the instant application relates;

FIG. 2b illustrates an encrypted LLC frame;

FIG. 3a illustrates a Dynamic Link Layer to which the instant application relates;

FIG. 3b illustrates transmission and reception sides of a Dynamic Link Layer to which the instant application relates;

FIG. 4 illustrates an example of a Home Area Network (HAN) to which the instant application relates;

FIG. 5a illustrates different networks connected together to which the instant invention relates;

FIG. 5b illustrates an example of a Home Area Network (HAN) connected to a utility server to which the instant invention relates; and

FIG. 6 illustrates a hardware implementation to which the present invention relates.

### SUMMARY

Secure message transfer is provided in a network or networks including at least a Home Area Network (HAN) having network devices A, B and C. The Home Area Network is capable to connect domains having different transmission formats and includes a secure communication protocol. Device A is capable to communicate at least one message to the device C according to the secure communication protocol, and device B is capable to receive at least one message from device A sent for reception and decryption by device C. Device D controls the secure message transfer and selectively disables device B from decrypting the message received by device B that is sent from device A to device C for decryption.

In another refinement, the message includes an overhead portion and a payload portion, and the overhead portion, which may include routing information, is decrypted.

In a further refinement, a part of the message is decrypted that includes a security key capable of being used to decrypt the message by device C according to the secure communication protocol.

Further, a header is constructed from the message received by device B from at least a part of the message. The header is used by device B to forward the message to device C.

As a further security measure, the security key is separately encrypted from the remainder of the message.

In addition, different security keys are generated and provided for communicating between different devices A, B or C.

Another measure to secure communication is to prepend a header to the message received by device B.

In addition to adding further security, by establishing the secure communication protocol in the PHY layer of any of devices A, B or C, a further effect of cost savings is achieved.

In a further refinement, the solutions provided herein are applied to a secure communication protocol that operates in accordance to any of G.9960, G.9961, G.hnem, home PNA, HomePlug, or IEEE 1901.

Furthermore, devices A, B or C are devices of any communication format, particularly xDSL, WLAN, PON or a Cable network.

These solutions are further incorporated into circuitry that selects portions of the message to be decrypted and store the decrypted message in a memory.

These and other solutions shall be explained in more detail with reference to the detailed description.

### DETAILED DESCRIPTION

The present invention provides a system, method and apparatus for secure communication in a Home Area Network.

In order to combat the problem of the open-ended HAN network that the un-encrypted security keys are open to any number of devices, bridges or domain masters, a solution is provided that maintains the keys in a secure state while being transported between devices.

As a further security measure, the encryption/decryption is provided to only certain devices in the HAN (or alien networks connected thereto). By selectively distributing the encryption/decryption capability to preselected devices, the invention reduces the amount of points where the security key could be hacked, thereby further improving robustness against hacking.

The ITU standards, such as G.9961, provide a basic outline for security measures in a home network. In general, security inside a HAN domain is provided by encryption of the relevant LLC frames communicated between the nodes of the domain. The encryption is based on the well-accepted advanced encryption standard (AES) and the counter with cipher block chaining message authentication code (CCM) algorithm. The CCM protocol (CCMP) includes the CCM encryption mechanism and a particular format for the encrypted LLC frame is communicated to facilitate decryption. Every pair of nodes in unicast and nodes of every multicast group communicating in a secure mode may use a unique encryption key. Authentication, generation, distribution of encryption keys between nodes, and periodical key and authentication updates are provided by a set of authentication and key management (AKM) procedures. The skilled artisan understands how to implement these encryption methodologies.

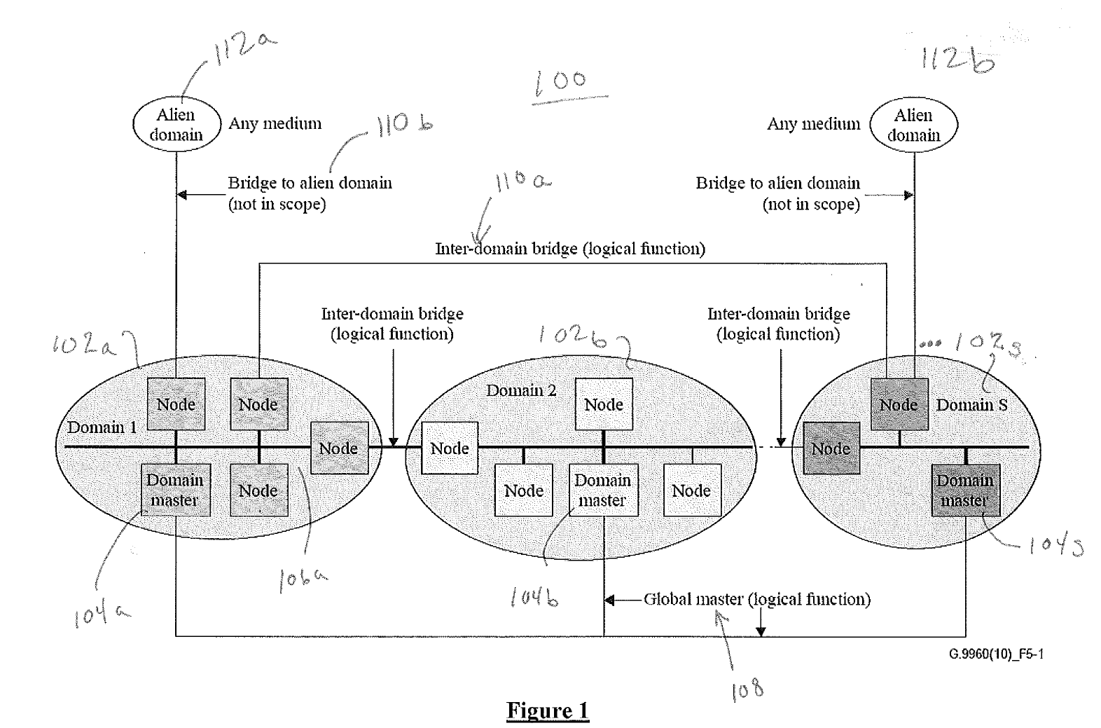

One lapse in security here is instantly recognized in the manner in which the encryption is managed amongst the different domains. Security of a network containing more than one domain is provided by setting all the domains of the network in secure mode. In a secure mode of operation, each of the domains of the HAN authenticate themselves to a security controller (SC). However, inter-domain bridges (FIG. 1) are automatically given the privilege of being secure. Such an assumption will immediately be seen as erroneous. In fact, security measures protecting inter-domain bridges are not accounted for at all, leaving a gaping hole for untrustworthy devices to enter the HAN by inserting itself at the bridge.

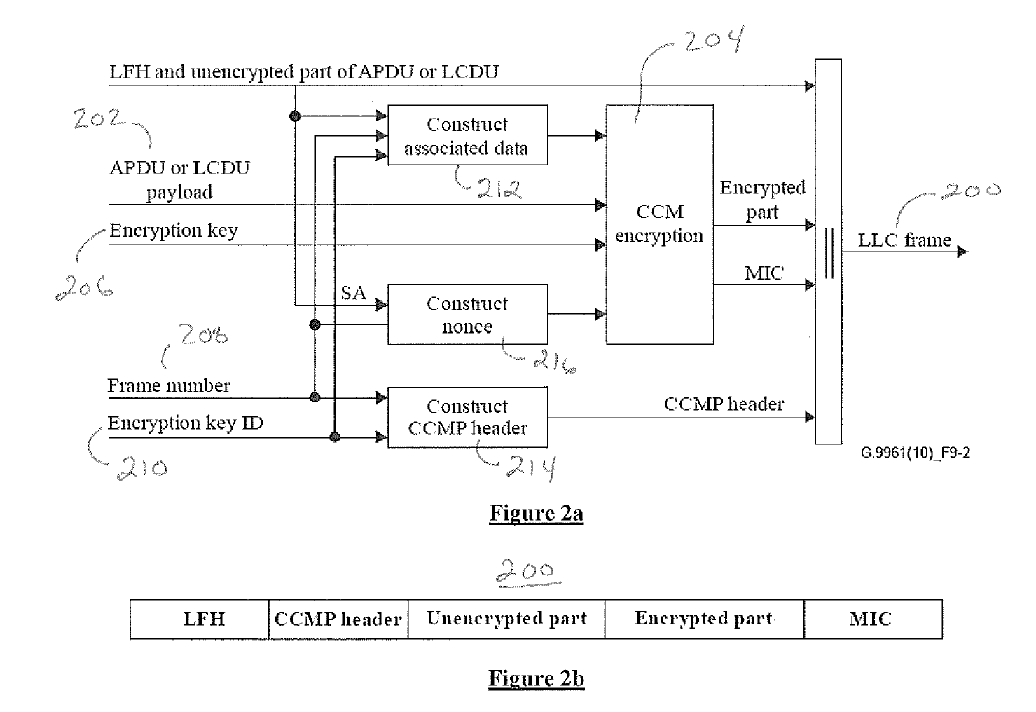

Continuing with the encryption discussion, the LLC frames 200 are produced as shown in FIG. 2a. An incoming Application Protocol Convergence Data Unit (APDU) or Link Control Data Unit (LCDU) 202 is encrypted by a CCM encryption function 204 using encryption key 206. The Logical link control Frame Header (LFH) is sent unencrypted. Both the LFH and the unencrypted part of the APDU (or LCDU) are protected by the Message Integrity Code (MIC) as a part of associated data. If the encrypted LLC frame cannot be authenticated, it is dropped by the receiver. The frame number (FN) 208, the key ID 210, and the length of the MIC associated with the encrypted LLC frame are used to construct the associated data (as indicated generally by 212), and also conveyed to the receive side in the CCMP header to assist decryption (as indicated generally by 214). The CCMP header is sent unencrypted, but is also protected by the MIC. The nonce (N), which is also used in the encryption, is constructed using the REGID of the domain master (SA) and the frame number 208 (as indicated generally by 216). The resulting encrypted LLC frame 200 and its format is presented in FIG. 2b. The frame includes the LFH and the encrypted APDU (or LCDU) that consists of four parts: CCMP header, unencrypted part, encrypted part (cipher text), and MIC.

Here the G.9961 standard belies yet another weakness in the currently accepted methodology. The encryption and decryption function of the Logical Link Control function as stipulated in the standard is performed at the source, which may not be on the same physical layer. Problematically, this difference between where encryption and decryption is performed can be exploited by interlopers. Using a piece of software known as a sniffer, traffic between layers can be detected and revealed. Moreover, and because the secure communication protocol is applied at the source, hackers can probe the source for clues on how to encrypt (and, therefore, decrypt) the security key.

A particular solution, explained in more detail below, is applied at the Physical Layer of the communication devices to transport the application payload units from source to destination, again without deciphering them on the way. The PHY layer is difficult to penetrate by hackers because no mechanisms exist to access information inside the PHY layer. By providing the solution to the encryption/decryption dilemma within the PHY, entirely or partially, an even more secure environment is achieved. In order to add simplicity of design, the key used for encryption may be the same key which is used for physical layer communication. Furthermore, the solution provides for encryption/decryption at the remote ends, with no decryption in between. Thus, where the source message is encrypted in the PHY, and the decryption is only provided at the remote end, unauthorized interception of the security key is mitigated.

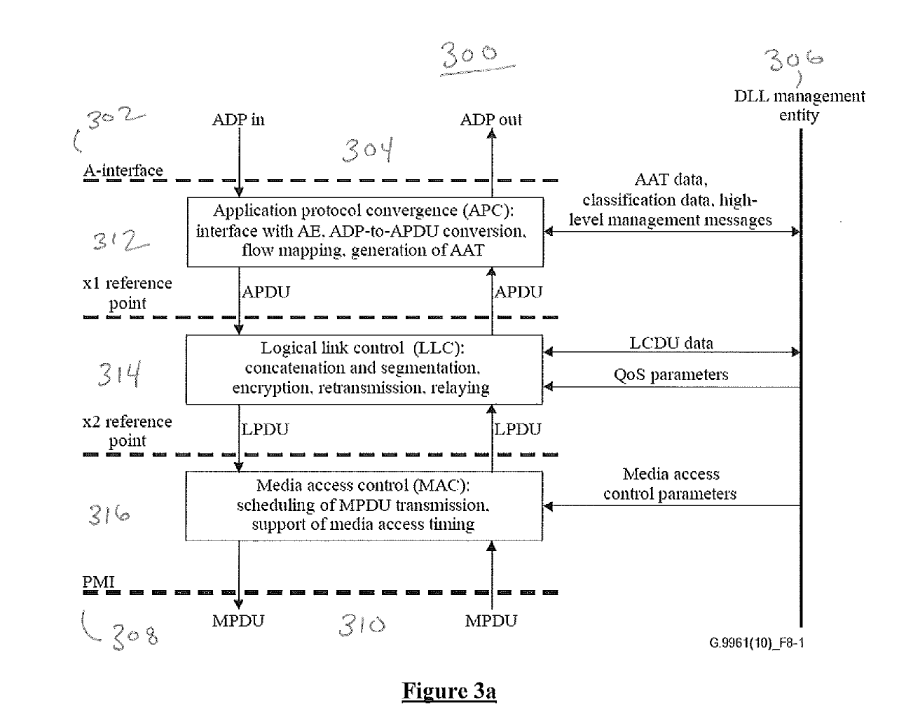

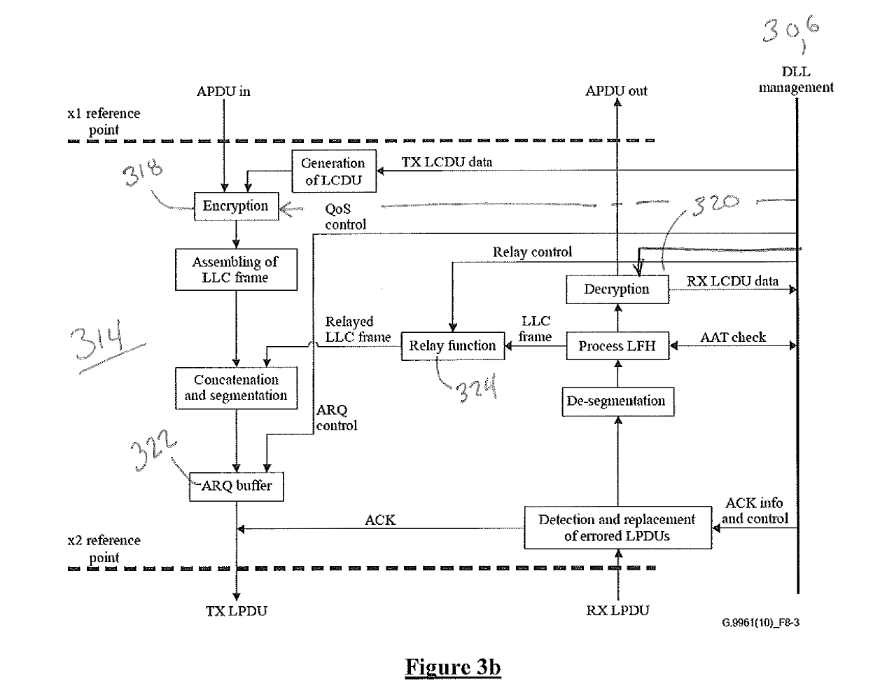

Turning now to solving the aforementioned problems and difficulties associated with securing communication in a Home Area Network (HAN), the solutions will present themselves in more detail with regards to FIGS. 3a and 3b. Generally, however, it shall be observed that the domain master (which for illustration purposes may be an interface modem to a WAN) transports the encrypted LCDUs in a virtual but Routable Ethernet/IP packet in a direct manner to the destination. As will be explained below, this may be done in several ways. One way is to prevent all devices from accepting messages that are not intended for a particular device. Another is to cause the routing devices to deliberately not decode the message. A further scheme causes the devices along the communication route to decode only enough of the header to be able to forward the messages. These arrangements may be used in conjunction or independently of one another.

Now a more detailed discussion will be set forth in regard to the functional model 300 of the data link layer (DLL) presented in FIGS. 3a and 3b. In FIG. 3a it is seen that an A-interface 302 is designated as the demarcation point between the application entity (AE) 304 and the data link layer (DLL) 306. The physical medium independent (PMI) interface 308 provides the demarcation point between the DLL 306 and the physical (PHY) layer 310. Internal reference points x1 and x2 show points of logical separation between the Application Protocol Convergence (APC) 312 and Logic Link Control (LLC) 314, and between the LLC 314 and Media Access Control (MAC) 316, respectively.

In operation, the APDUs are transferred to the LLC across the x1 reference point, which is both application independent and medium independent. In addition, LLC 314 receives management data primitives from the DLL management entity 306 intended for LLC control frames, which are mapped into link control data units (LCDUs). The LLC 314 is responsible for establishing flows of LCDU (control frames) between peer LLCs.

In the LLC 314, the incoming APDU and LCDU are converted into LLC frames and may be encrypted using assigned encryption keys which is explained later in more detail. LLC frames are subject to concatenation and segmentation, and the segments are transformed into LLC protocol data units (LPDUs) by adding an LPDU header (LPH) and CRC. The LPDUs are then passed to the MAC 316 across the x2 reference point. The LLC 314 is also responsible for retransmission and relay operations.

The MAC 316 is responsible for concatenating LPDUs into MAC protocol data units (MPDUs) and then conveying these MPDUs to the PHY 310 in the order determined by the LLC 314 (scheduling, using number of transmission queues) and applying medium access rules established in the domain. In the receive direction, MPDUs from the PHY 310 enter the MAC 316 across the PMI 308 together with associated PHY frame error information. The MAC 316 disassembles the received MPDU into LPDUs, which are passed over the x2 reference point to the LLC.

The LLC 314 recovers the original APDUs and LCDUs from the LPDUs, performs decryption if required, and conveys them to the APC 312 and LLC management entity, respectively. In the APC, ADPs are generated from the received APDUs and conveyed to the AE 304. The LLC 314 is responsible for the decision regarding errored LPDUs. It decides whether to request retransmission of errored LPDUs (and generates the ACK response to assist retransmission), or to discard the errored LPDUs.

With reference to FIG. 3b, a more pronounced discussion shall be set forth in regards to the LLC 314. APDUs (for example, Ethernet frames) enter the x1 reference point and are encrypted (indicated generally by 318), including any header applied to the data. At the far-end, the receiver decrypts the frame including the header and forwards the decrypted packet back out the x1 interface (as generally indicated by 320).

The LLC management data to be conveyed is assembled into an LCDU and further mapped into an MPDU. LPDUs that are subject to Automatic Repeat Request (ARQ) (i.e., need to be retransmitted) are extracted from the ARQ buffer 322 and passed to the MAC 316 to be assembled into the outgoing MPDU. To assist retransmission, the receive part of the LLC generates ACKs, which are also passed to the MAC 316. The number of LLC frames to be concatenated, the size of the segment, and other MPDU formatting parameters are controlled by the LLC 314. The LPDUs are passed to the MAC 316 across the x2 reference point shown in FIG. 3b.

In the receive direction, the incoming MPDU is disassembled into LPDUs in the MAC 316 and passed over the x2 reference point. The LLC 314 verifies the LPDUs, requests replacements for any errored LPDUs if so instructed, and recovers LLC frames from the LPDUs. The recovered LLC frames are decrypted and passed to the APC 312 as APDUs. Recovered LCDUs are passed to the DLL management entity 306.

A relay function 324 extracts LLC frames that are subject to relaying and passes them to the transmit side, which concatenates them into the traffic to the next hop. DLL management 306 controls flow and priority settings for the relayed LLC frames. The relay is performed on the media access control (MAC) side and is, therefore, susceptible to hacking. This is in contradistinction to the PHY layer which is more durable against attacks owing to the lack of signaling provided by the PHY layer. Further, the relay function lacks the control necessary to selectively enable/disable encryption and/or decryption.

A problem mentioned above is that the receiving device that decrypts the message (320), including the encrypted key, may be an intervening or interim device or node that is being used to pass on the message. In that case, the interim node has no business decrypting the encrypted key. To address the issue the receiver is prevented from decrypting frames as described above, but instead bypasses the decryption. The frames are then automatically forwarded to the next node or device. This is achieved by selectively disabling the decryption mechanism. Most network devices provide a generic mechanism to allow turning on/off the encryption/decryption. This is performed in one aspect to be part of the control information sent from the DLL management 306. In another aspect, the DLL management 306 sends a control signal to the decryption unit to selectively disable encryption and/or decryption. In still another aspect, a bit or flag is set to enable and/or disable the encryption and/or decryption.

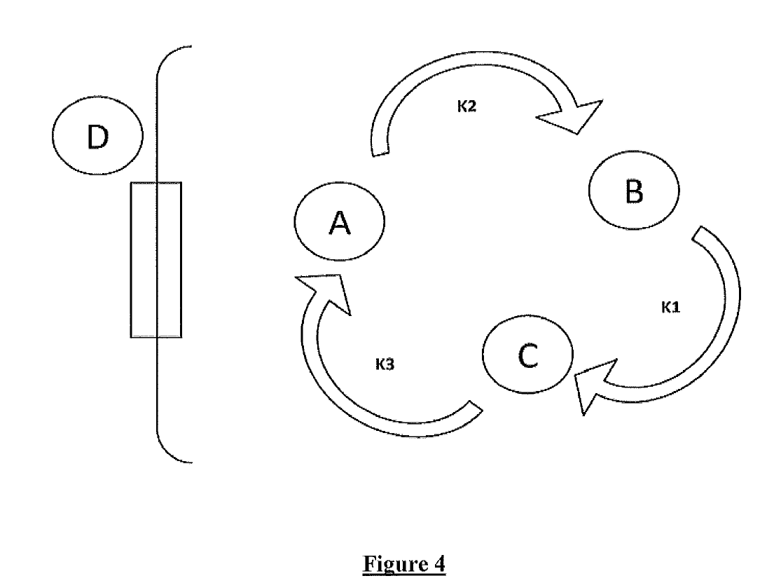

The situation is better understood with an explanation of a secure communication with respect to FIG. 4 that illustrates a home network environment in which three devices A, B, and C are shown to form the communication link. In an illustrative example, the device A may be a WAN interface device (non PLC modem), B may be a WAN interface PLC modem, and C may be a destination PLC modem. The problem becomes apparent when it is considered that device A attempts to “talk” to device C securely, but each device only has access through device B. Communication from A to B is over, for example, the WAN, and communication from B to C is over the PLC device. As already described, devices A, B and C are arranged to communicate over the HAN. The gateway D, which acts as a firewall, may provide the coordination for the security of the Home Network. This coordination function may be the secure functionality discussed above with respect to G.9961.

To address the issue of transmitting unencrypted data over the WAN by PLC modem B, in one embodiment device B is prevented from decrypting frames as described above. Device B is caused to bypass the decryption, and forward the already-encrypted packet to device C. As already noted most network devices allow a generic mechanism to turn the encryption/decryption on/off.

Selectively enabling/disabling the encryption/decryption at an interim device or node B will be appreciated as a viable solution. Typically, this should be sufficient in an IP network that does not encrypt the headers. However, there are instances where the encrypted packet does not represent a routable frame. This could be because the frame header remains encrypted and, therefore, the device B does not know where to route the frame. Thus, refinements to this approach are now herein described.

One solution to the immediate problem is available for point-to-point connections. In that case, a usable header or (or portions of the header, especially those consisting of the destination node's address—i.e., routing information, address name, location, etc.) is constructed statically and stored in B's memory. The header is typically located in the overhead portion, as opposed to the payload. The header, which in IP networks is not encrypted, is decoded and used as a new constructed header. The constructed header is then pre-pended according to this refinement to the encrypted frame and forwarded, thereby allowing higher-layer equipment (for example, Ethernet devices) to process the frame. A gateway or master device D described below provides the coordination and prepended headers to the other devices.

For a multipoint connection, device B is caused to decode a portion of the higher layer frame—at least enough to extract the existing header. Because of the nature of the encryption function, B cannot transmit the existing header in decrypted form. However, device B can use the information in that header to generate a new header and prepend that to the entire encrypted frame. Further, the constructed header may include the original header. The structure of the frames is ascertained from the various standards in Home Networking, with one such example and its construction being described with reference to FIGS. 2a and 2b.

In a further refinement of this solution, the header that is constructed (or reconstructed) is encrypted separately from the message. This is appropriate, for example, in cases where the device is not a trusted intermediary but where the static header is insufficient to route the message to its end destination. In IP networks, a static header is the header at the beginning of the message that is typically not encrypted. In that case, separate security credentials (i.e. keys) can be arranged between the three devices (A, B, C) in the communication link. This allows the header to be encrypted separately from the payload of the frame so that device B, in our example of FIG. 4, decrypts the header but is not capable to decrypt the payload.

To address the issue in the opposite direction—that is when device (or node) A transmits unencrypted data to B—the reverse procedure can be applied. That is, A transmits data to B as a fully-encrypted Ethernet frame. Because the transmitted encrypted frame does not have a valid header, the solution here directs device A to prepend a duplicate header to the frame. B then is directed to remove that header and, in addition, bypass its encryption function because the frame is already encrypted.

In our example of FIG. 4, devices (or nodes) A and C are given matching security keys. This is not a problem in principle because both devices can use one of the standard key exchange protocols (e.g. Diffie-Hellman). It will be appreciated that, as an additional security measure, the actual encryption/decryption algorithm can be modified in order that a hacker is not capable of intercepting the key and use a software decrypting algorithm.

As mentioned above, standards such as G.9961 coordinate key exchange through an intermediate Security Controller (SC). Problematically, device A—the WAN device of our example, does not have access to the controller as it is not a PLC modem. Since the SC is in the PLC network, the solution here directs the PLC modem B to forward security messages from device A to the SC.

In a further refinement of the solutions provided above, the header is decrypted using separate keys for pairs of devices. This is performed in our example of FIG. 4 using keys K1, K2, and K3, which may be provided by device D for encryption/decryption of the header between devices A, B or C. In that case, the solution here provides device A with only those keys or key that is relevant for that device. For device A the relevant keys are K2 and K3, while Device B is informed of only keys K1 and K2 and Device C is informed of only keys K3 and K1. In that regard, there is provided a further security measure that allows the respective device to decrypt only the headers of the message that is relevant for that device.

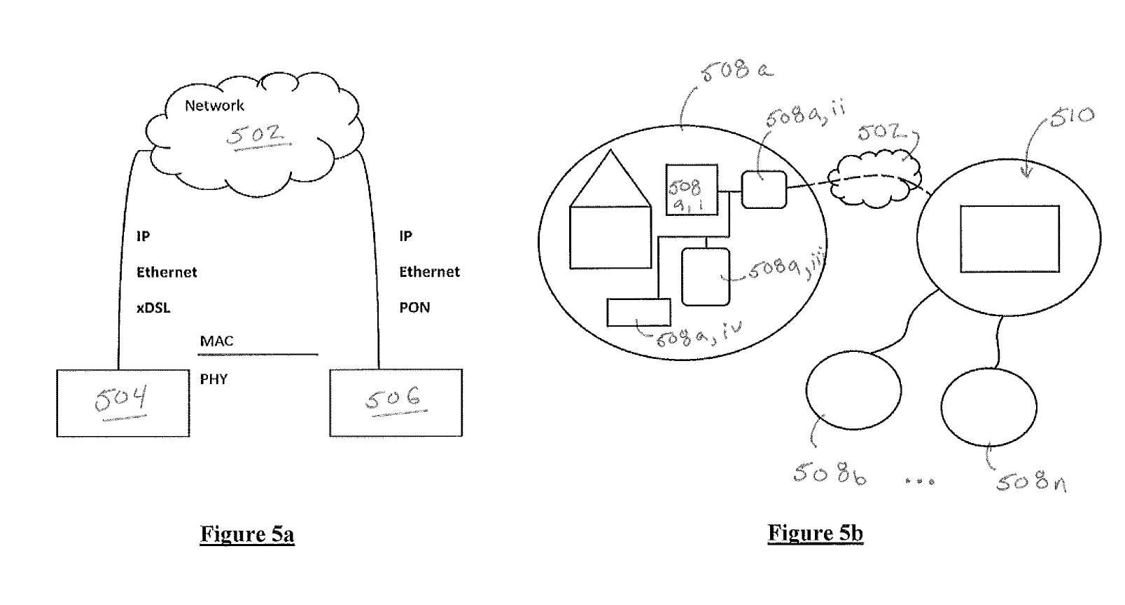

Another important issue is that some countries protect the private or confidential information of users, such as personal data or bio data, from third parties. In Europe, for example, it is a requirement by law that the information of the user be protected, violation of which can have severe sanctions for a company. In that case, the present invention is important for enabling network carriers and device manufacturers to provide assurances to secure personal information of its users and customers. The situation is further addressed with respect to FIGS. 5a and 5b.

As shown in FIG. 5a, each network may be considered a secure area. When, however, the data leaves a residence and enters into an external network 502, such as the world- wide-web or internet, it is no longer safe from decryption. Left unprotected, the information of the user may be open for any third party to exploit. This is problematic in the particular case of home area networking (HAN) where personal information of the user is often transmitted. The personal information could be, for example, metering information sent back to the power company. Or it may be credit card information sent to an online video rental company. Photo albums or other bio data may be uploaded to an internet server.

For example, a xDSL environment 504 sends personal data to another network 506, such as a PON network. The PON network may be in the same or different Home Network, such as an internal domain, or may be an alien domain (FIG. 1). In such a case, the traditional security implementations will not work because the different systems (DSL versus PON) have different security protocols. The arrangements described herein provide a solution to this problem by offering a universal mechanism for securing the encryption keys. For example, when xDSL environment 504 sends a message to a remote network that is intercepted or forwarded by PON network 506, the PON network is prevented from decrypting the message as already described. Alternatively, or in addition, the PON network 506 decrypts only a portion of the received frames sufficient to allow it to forward the frames. And also as described above, the PON network 506 is given separate keys for decrypting the headers that are/were encrypted separately from the rest of the message.

It shall be noted from FIG. 5a that the MAC is delineated here from the PHY layer where the encryption/decryption is provided. It shall also be noted with respect to FIG. 5a that several layers of encryption that lie over the base communication provide further security layers in addition to the that described above. In the figure there is shown the first encryption at the xDSL or PON level, for example, followed by encryption at the Ethernet and/or IP level. In accordance with solutions already discussed, the header portion may be encrypted separately from the security key. This could be, for example, achieved by encrypting the header according to one of these other encryption methods, whilst the key and/or message remains encrypted according to the secure communication protocol provided by the HAN. In this manner, the invention further provides additional security without adding further processing needed to encrypt the headers separately.

As explained above, countries such as those in Europe are particular about privacy of information laws. The problem is quite important to public utility companies that deal with personal information. In regards to the power utility companies or water supply companies, information on consumption of energy or water could be considered private information when patterns of usage are revealed by such information. These utilities are, therefore, keen on finding a solution to this problem. France and Italy, for example, have taken approach that an integrated meter box including the encryption/decryption functionality be provided. In that case, the external power lines that connect from the outside to the residences shall themselves be used to transport the utility information of the user. In Germany, the utilities prefer a third party, such as broadband network or company, to provide communication between the meter box and the utility company. In that case, an additional box communicates the utility information of the user over, for example, a broadband network.

In either of the cases above, the solutions provided herein resolve the concerns of the utility companies. For example, with respect to FIG. 5b a HAN 508a situated at a residence connects to the outside world through an external network 502 to an external or alien domain 510, which may be a server at a utility company. Indeed, a number of HANs 508b . . . n may optionally connect to the utility company server 510. The HAN 508a may include, for example, a meter 508a,i that reads utility information for electricity, water, gas, oil, heat, etc. A communication box or function 508a, ii is shown to provide connection to the external domain 510. The meter 508a, i may be a smart meter in which the communication functionality is integrated therein, as is the case in France and Italy. Further, there may be provided an appliance 508a, iii for connection to the meter. Optionally, a digital display 508a, iv may be provided with the meter or may be separate therefrom by which the user can interface.

In operation, usage information is gathered by the meter 508a, i. This is encapsulated in a message and encrypted. As explained, this information represents personal or private (confidential) information of a user, particularly when it exhibits a pattern of usage. The encryption is performed at the meter 508a, i by the communication function or device 508a, ii. For this purpose, the encryption keys may be established by the utility at the plant where the meters are made and stored, for example, in a ROM or PROM within the meter. Accordingly, the communication function or device 508a, ii forwards the encrypted message to the utility server. Any interim device or node, such as within the residence or otherwise is restricted from decrypting the message (or at least that part of the message containing the encrypted key). In addition, the encryption is performed as explained at the PHY layer, making interception of the key even more robust against intrusive attacks.

In the opposite direction, the solution provides decryption only by the communication function or device 508a, ii, which again may be integrated into the meter 508a, i. In that case, no other node in the home area network (HAN), such as the appliance or any bridges in between, are allowed to decrypt the message. Once the communication function has decrypted the message from the utility company it may send the information to the display 508a, iv of the user. In accordance with the above, the information sent to the display is also encrypted according the secure communication protocol and delivered to the display. Again, all other nodes or devices connected to the HAN are prevented from decrypting the information (at least the encrypted key) that is intended for the display.

Therefore, with the present solutions personal (confidential) user information is secure in both the local Home Network and as well when the information is transported to other protocols or external networks. In an arrangement where the message includes the encryption key or other security keys, solutions are provided that protect from the hacking of these messages as well. Of course, the other aspects of the herein-described solutions are applicable here as well. For example, partial decryption and header construction as explained above may also be applied to the utility situation.

Further, the solutions set forth above are advantageously provided in a hardware form. The solution could be implemented using hardware, software or a combined approach, utilizing the security of hardware with the resiliency of software. With a combined approach, a solution is provided that is at once secure yet cost effective and reproducible for many devices. For example, the encryption key is generated using logic provided by hardware and other functions provided by software. In another example, the security key may be burned into a logical device, such as a PROM.

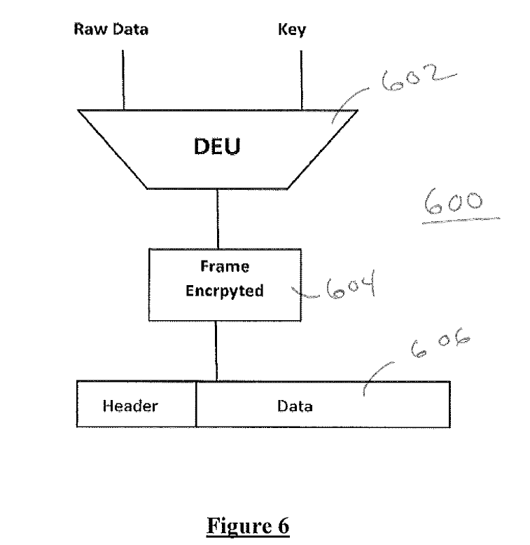

FIG. 6 illustrates a possible hardware solution in the form of circuit logic 600 including, for example, a data encryption unit (DEU) 602 that receives raw data and a key, an encrypter 604 and a memory 606 (such as a buffer of register) for outputting the frame shown as including a header and frame. In that regard, the proposed solution provides for encrypting/decrypting the frame selectively based on instructions. The encrypter 604 can also encrypt/decrypt only the header of the frames based on separate keys, as also herein described. As discussed the solutions provided herein may be implemented in the PHY, thereby providing additional security and resistance against hacking.

Basing the encryption in hardware, particularly at the PHY level, there is further the advantage to allow these various networks with different protocols to provide security seamlessly over different protocols and networks. As explained, the PHY layer is typically difficult to penetrate by hackers because no mechanisms exist to access information inside the PHY layer. In that case, the security burden is distributed amongst different PHY or MAC layers of different devices or network environments. This also reduces complexity and ensures universal integration of the encryption standard.

Notably the above solutions work seamlessly with existing Systems that utilize Software for encrypting and/or decrypting messages. These arrangements can thus be provided to reduce the amount of legacy devices using software for encryption and/or decryption thereby improving security in those Systems. Thus, a system, method and apparatus are provided for secure communication in a Home Area Network.

1. A method for secure message transfer in a Home Area Network (HAN), the HAN having at least a first network node, a second network node and a third network node, the HAN being configured for communication according to a secure communication protocol, the method comprising:
communicating an encrypted message from the first network node to the second network node according to the secure communication protocol, and
communicating the encrypted message from the second network node to the third network node according to the secure communication protocol,
selectively disabling the second network node from decrypting at least a secure portion of the encrypted message.

2. The method of claim 1, wherein the encrypted message includes routing information associating the encrypted message with the third network node as a recipient of the encrypted message, further comprising the step of using the routing information in constructing a header for use in communicating the encrypted message from the second network device to the third network device.

3. The method of claim 1, the method further comprising the step of decrypting, at the second network node, at least a routing portion of the encrypted message, the routing portion including routing information.

4. The method of claim 1, further comprising that the step of communicating from the second network node to the third network node communicates the encrypted message between an alien domain and a server of a utility company.

5. The method of claim 1, the method further comprising the step of providing, at the first network node, a security key for use in processing a routing portion associated with the encrypted message at the second network node.

6. The method of claim 1, further comprising the step of applying the secure communication protocol in a physical communication layer of a node consisting of the group selected from the first node and the third node.

7. The method of claim 1, the method further comprising routing the encrypted message over at least one domain having a transmission format selected from a group consisting of: xDSL, WLAN, PON, Powerline network, and Cable network.

8. The method of claim 1, wherein the secure communication protocol is provided according to any of G.9960, G.9961, G.hnem, home PNA, HomePlug, and IEEE 1901, or successor standards.

9. The method of claim 1, further comprising a non-transitory computer-readable medium that stores instructions to control a computer in accordance with the steps of claim 1.

10. An apparatus for use in a network, the network having at least a first network node, a second network node and a third network node and being configured for communication according to a secure communication protocol, and the apparatus being for use at the second network node, comprising:
a circuit that receives an encrypted message communicated according to the secure communication protocol from the first network node to the second network node,
wherein, the circuit is configured to selectively disables the second network node from decrypting at least a secure portion of the encrypted message.

11. The apparatus of claim 10, wherein the encrypted message includes routing information associating the encrypted message with the third network node as a recipient of the encrypted message, wherein the circuit is further configured to construct a header using the routing information for use in communicating the encrypted message from the second network device to the third network device.

12. The apparatus of claim 10, the circuit is further configured to decrypt, at the second network node, at least a routing portion of the encrypted message, the routing portion including routing information.

13. The apparatus of claim 10, wherein the encrypted message includes personal information, second node is an alien domain, and the third node is a server of a utility company.

14. The apparatus of claim 10, the circuit is further configured to use a security key for processing a routing portion associated with the encrypted message at the second network node.

15. The apparatus of claim 10, the circuit is arranged in a physical communication layer of a node consisting of the group selected from the first node and the third node.

16. The apparatus of claim 10, wherein the HAN includes at least one domain having a transmission format selected from a group consisting of: xDSL, WLAN, PON, Powerline network, and Cable network.

17. The apparatus of claim 10, wherein the secure communication protocol is provided according to any of G.9960, G.9961, G.hnem, home PNA, HomePlug, and IEEE 1901, or successor standards.
